(19) United States
(12) Patent Application Publication
(10) Pub. No.: US 2023/0006490 A1
(43) Pub. Date: Jan. 5, 2023

(54) ROTOR CORE AND MOTOR INCLUDING THE ROTOR CORE

(71) Applicant: Nidec Corporation, Kyoto (JP)

(72) Inventors: Guo-Jhih YAN, Taipei City (TW); Keng-Chang WU, Taipei City (TW); Kuo-Min WANG, Taipei City (TW)

(21) Appl. No.: 17/778,616

(22) PCT Filed: Sep. 30, 2020
(86) PCT No.: PCT/JP2020/037351

§ 371 Date: May 20, 2022

(30) Foreign Application Priority Data
Dec. 31, 2019 (CN) 201911408814.8

(51) Int. Cl. H02K 1/276; H02K 1/28; H02K 1/02

(52) U.S. Cl. CPC H02K 1/2773; H02K 1/28; H02K 1/02

(57) ABSTRACT

In a rotor core and a motor including the rotor core, a rotor yoke includes magnetic pole core groups arranged in a circumferential direction and each including a magnetic conductor at a center and permanent magnets around the magnetic conductor. A center of each magnetic pole core group is defined by the magnetic conductor, so that the number of magnets used can be reduced to achieve low cost. The permanent magnets around the magnetic conductor increases a magnetic flux concentration effect while preventing magnetic flux leakage to achieve high efficiency and high performance.

### CROSS-REFERENCE TO RELATED APPLICATIONS

This is a U.S. national stage of application No. PCT/JP2020/037351, filed on Sep. 30, 2020, with priority under 35 U.S.C. § 119(a) and 35 U.S.C. § 365(b) being claimed from CN Patent Application No. 201911408814.8, filed on Dec. 31, 2019, the entire disclosures of which are hereby incorporated herein by reference.

### 1. FIELD OF THE INVENTION

The present application relates to the electric and mechanical field, and particularly relates to a rotor core and a motor including the rotor core.

### 2. BACKGROUND

Axial flux motors are different from general motors. The axial flux motors each have an axial direction as a magnetic flux direction, and a stator and a rotor core that are formed in a disk type. The axial flux motors have advantages such as compact structure, small volume, light weight, and high torque density.

Typical radial flux type motors are often designed such that a magnet is incorporated to achieve both high performance and high efficiency while the number of magnets to be used is reduced in response to demand for large power or large dimensions. Unfortunately, the axial flux motors are rarely designed to incorporate a magnet due to a difference in magnetic flux direction from general radial flux motors and limitation by a manufacturing method.

Although some axial flux motors designed to incorporate magnets are currently available, the magnets are typically disposed in a circumferential direction in these designed motors.

It should be noted that the above introduction to the technical background merely serves to facilitate understanding of those skilled in the art while helping to provide a clearer and more complete description of the technical idea of the present disclosure. The foregoing technical manners described in the technical background section of the present application should not be simply considered to be publicly known to those skilled in the art.

Unfortunately, these conventional designs have one or more of problems as follows: a rotor has a complicated structure; another mechanical structure for maintaining rigidity of the rotor is required; magnets need to be gathered one by one in a manufacturing process; a cumulative error is likely to occur, and thus a complete rotor cannot be formed; and the axial flux motor has a three-dimensional (3D) structure, and thus a phenomenon of magnetic flux leakage still occurs around magnetic pole surfaces of the magnets.

### SUMMARY

The present disclosure provides example embodiments of a rotor core and a motor including the rotor core. When a rotor yoke according to a preferred embodiment of the present disclosure is provided with magnetic pole core groups in a circumferential direction and each magnetic pole core group includes a magnetic conductor at its center and permanent magnets around the magnetic conductor, the structure becomes compact and reliable as a whole such that another mechanical structure to maintain rigidity of the rotor is not required. Methods for manufacturing magnetic pole core groups according to other example embodiments of the present invention facilitate mass production and manufacturing without causing a cumulative error in manufacturing and assembly. The center of each magnetic pole core group is defined by the magnetic conductor, so that the number of magnets to be used can be reduced at the maximum to achieve low cost. Then, the permanent magnets around the magnetic conductor enables increasing magnetic flux concentration effect while preventing magnetic flux leakage. Thus, both high efficiency and high performance of the motor can be achieved.

The present disclosure provides example embodiments of rotor cores and a motors including the rotor cores, in each of which a rotor yoke is provided with magnetic pole core groups in a circumferential direction and each magnetic pole core group includes a permanent magnet at its center and permanent magnets around this permanent magnet, so that structure becomes compact and reliable as a whole, and thus another mechanical structure to maintain rigidity of the rotor is not required. The method for manufacturing the magnetic pole core groups facilitates mass production and manufacturing without causing a cumulative error in manufacturing and assembly. Both the center and the periphery of each magnetic pole core group are defined by the permanent magnets, so that the magnetic flux concentration effect can be increased while magnetic flux leakage is prevented. Thus, high efficiency and high performance of the motor can be ensured to the maximum.

A first example embodiment of the present disclosure provides a rotor core including a rotor yoke including silicon steel sheets stacked in an axial direction of the rotor yoke and magnetic pole core groups accommodated in respective accommodation holes in the rotor yoke in a circumferential direction of the rotor yoke. The magnetic pole core groups each include a magnetic conductor at a center of each magnetic pole core group and first permanent magnets around a periphery of the magnetic conductor. The first permanent magnets each have a magnetic pole direction that points radially inward or radially outward of each of the magnetic pole core groups.

According to a second example embodiment of the present disclosure, the magnetic pole core groups include two adjacent magnetic pole core groups including the respective first permanent magnets that are opposite to each other in the magnetic pole direction.

According to a third example embodiment of the present disclosure, the magnetic conductor includes a polygonal section taken along the axial direction, and the first permanent magnets are each a rectangular parallelepiped.

According to a fourth example embodiment of the present disclosure, the magnetic conductor is larger in dimension in the axial direction than each of the first permanent magnets.

According to a fifth example embodiment of the present disclosure, the magnetic conductor protrudes from an end surface of the rotor yoke, the end surface being close to a stator in the axial direction.

According to a sixth example embodiment of the present disclosure, the rotor core includes rotor structures in at least two layers. Each of the rotor structures of the layers includes the rotor yoke and the magnetic pole core groups. The rotor core further includes a spacing structure between adjacent rotor structures in two layers, and the spacing structure includes second permanent magnets connecting magnetic conductors corresponding to the adjacent rotor structures in the two layers.

According to a seventh example embodiment of the present disclosure, the magnetic conductors corresponding to the adjacent rotor structures in two layers are identical or different in dimension in a section taken along the axial direction.

According to an eighth example embodiment of the present disclosure, the magnetic conductors corresponding to the adjacent rotor structures in two layers are different in dimension in a section taken along the axial direction, and each of the second permanent magnets connecting the corresponding two magnetic conductors has two end surfaces in the axial direction, the two end surfaces being different in dimension.

A ninth example embodiment of the present disclosure provides a rotor core including a rotor yoke including silicon steel sheets stacked in an axial direction of the rotor yoke and magnetic pole core groups accommodated in respective accommodation holes in the rotor yoke in a circumferential direction of the rotor yoke. The magnetic pole core groups each include a third permanent magnet at a center of each magnetic pole core group, and fourth permanent magnets around a periphery of the third permanent magnet. The third permanent magnet has a magnetic pole direction that points to one side in the axial direction, and the fourth permanent magnets each have a magnetic pole direction that points radially inward or radially outward of each of the magnetic pole core groups.

According to a tenth example embodiment of the present disclosure, the magnetic pole core groups include two adjacent magnetic pole core groups including the fourth permanent magnets that are opposite to each other in magnetic pole direction, and the magnetic pole core groups include two adjacent magnetic pole core groups including the respective third permanent magnets that are opposite to each other in magnetic pole direction.

According to an eleventh example embodiment of the present disclosure, the third permanent magnet includes a polygonal section taken along the axial direction, and the fourth permanent magnets are each a rectangular parallelepiped or a wedge-shaped cube.

According to a twelfth example embodiment of the present disclosure, the third permanent magnet is larger in dimension in the axial direction than each of the fourth permanent magnets.

According to a thirteenth example embodiment of the present disclosure, the third permanent magnet protrudes from an end surface of the rotor yoke, the end surface being adjacent to the stator in the axial direction.

According to a fourteenth example embodiment of the present disclosure, the magnetic pole core groups each include the fourth permanent magnets close to a center hole of the rotor yoke, the fourth permanent magnets being positioned around the center hole.

A fifteenth example embodiment of the present disclosure provides a motor including the rotor core according to any one of the first to fourteenth example embodiments of the present disclosure.

Example embodiments of the present disclosure are disclosed in detail with reference to the following description and the accompanying drawings. It should be understood that the example embodiments of the present disclosure are not limited in scope by the disclosure. Within the spirit and scope of the appended claims, the example embodiments of the present disclosure include many changes, modifications, and equivalents.

Descriptions of one example embodiment and/or features exhibited can be used for one or more other example embodiments in an identical or similar manner, and can be combined with features of the other example embodiments or switched with the features of the other example embodiments.

It should be emphasized that although the terms, “including/containing/comprising” is used in the present text to indicate presence of a feature, a body shaper, or a portion, presence or addition of one or more other features, body shapers, or portions is not precluded.

The above and other elements, features, steps, characteristics and advantages of the present disclosure will become more apparent from the following detailed description of the example embodiments with reference to the attached drawings.

### BRIEF DESCRIPTION OF THE DRAWINGS

Detailed description below in association with the accompanying drawings will clarify the foregoing and other objects, features, and advantages in the example embodiments of the present disclosure. Accompanying drawings are as follows.

FIG. 1 is a plan view of a rotor core according to a first example embodiment of the present disclosure.

FIG. 2 is a bottom view of the rotor core according to the first example embodiment of the present disclosure.

FIG. 3 is a sectional view of the rotor core according to the first example embodiment of the present disclosure.

FIG. 4 is an exploded view of a rotor core with another structure according to the first example embodiment of the present disclosure.

FIG. 5 is an exploded sectional view of the rotor core with the other structure according to the first example embodiment of the present disclosure.

FIG. 6 is a sectional view of the rotor core with the other structure according to the first example embodiment of the present disclosure.

FIG. 7 is a plan view of partial structure of the rotor core according to the first example embodiment of the present disclosure.

FIG. 8 is a front view of the partial structure of the rotor core according to the first example embodiment of the present disclosure.

FIG. 9 is an exploded view of a rotor core with yet another structure according to the first example embodiment of the present disclosure.

FIG. 10 is an exploded sectional view of the rotor core with the yet other structure according to the first example embodiment of the present disclosure.

FIG. 11 is a sectional view of the rotor core with the yet other structure according to the first example embodiment of the present disclosure.

FIG. 12 is a plan view of another partial structure of the rotor core according to the first example embodiment of the present disclosure.

FIG. 13 is a front view of the other partial structure of the rotor core according to the first example embodiment of the present disclosure.

FIG. 14 is a plan view of a rotor core according to a second example embodiment of the present disclosure.

FIG. 15 is a bottom view of the rotor core according to the second example embodiment of the present disclosure.

FIG. 16 is a sectional view of a motor according to a third example embodiment of the present disclosure.

### DETAILED DESCRIPTION

With reference to the drawings, the following description will clarify the foregoing and other features of the present disclosure. It should be noted that although the specification and drawings specifically disclose specific example embodiments of the present disclosure and show some of the example embodiments in which the principle of the present disclosure is applicable, the present disclosure is not limited to the described example embodiments, and includes all modifications, variations, and equivalents falling within the scope of claims appended.

In the present disclosure, a direction parallel to a direction extending along a center axis is referred to as an “axial direction”, a radial direction centered on the center axis is referred to as a “radial direction”, and a circumferential direction around the center axis is referred to as a “circumferential direction”. It should be noted that the directions are defined in the present disclosure for convenience of description of the example embodiments of the present disclosure, and thus do not limit directions at the time of use or manufacture of the rotor and the motor.

Hereinafter, a rotor core and a motor according to an example embodiment of the present disclosure will be described with reference to the accompanying drawings.

A first example embodiment of the present disclosure provides a rotor core.

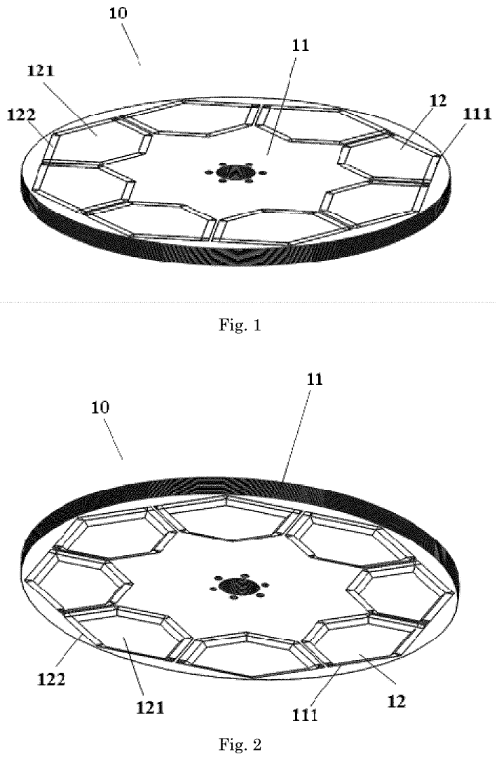

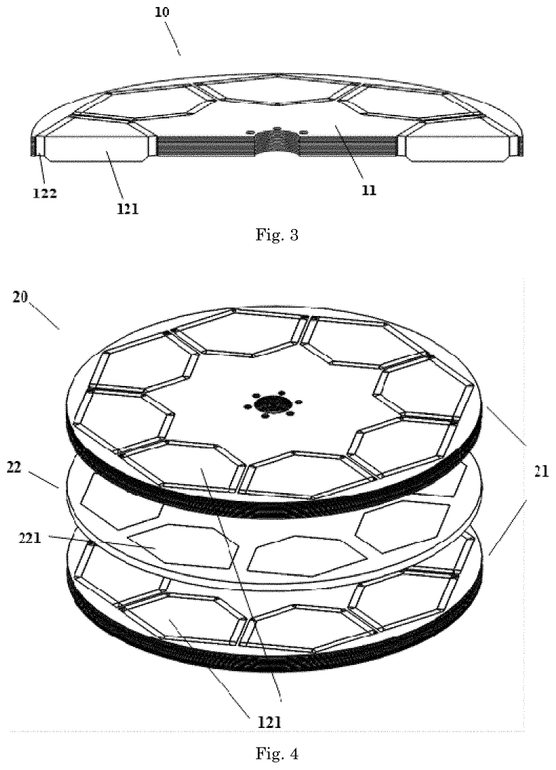

FIG. 1 is a plan view of the rotor core according to the first example embodiment of the present disclosure. FIG. 2 is a bottom view of the rotor core according to the first example embodiment of the present disclosure. FIG. 3 is a sectional view of the rotor core according to the first example embodiment of the present disclosure.

As illustrated in FIGS. 1, 2, and 3, a rotor core 10 includes a rotor yoke 11 formed by stacking multiple silicon steel sheets in an axial direction of the rotor yoke 11; and multiple magnetic pole core groups 12 accommodated in respective accommodation holes 111 provided in the rotor yoke 11 in a circumferential direction of the rotor yoke 11. The magnetic pole core groups 12 each include a magnetic conductor 121 provided at a center of each magnetic pole core group and multiple first permanent magnets 122 provided around a periphery of the magnetic conductor 121. The multiple first permanent magnets 122 each have a magnetic pole direction that points radially inward or radially outward of each of the magnetic pole core groups 12.

Then, when the rotor yoke 11 is provided with the multiple magnetic pole core groups 12 in the circumferential direction and each magnetic pole core group 12 includes the magnetic conductor 121 at its center and the multiple permanent magnets 122 around the magnetic conductor, structure becomes compact and reliable as a whole, and thus another mechanical structure for maintaining rigidity of the rotor is not required. The method for manufacturing the magnetic pole core groups 12 facilitates mass production and manufacturing without causing a cumulative error in manufacturing and assembly. The center of each magnetic pole core group is formed of the magnetic conductor, so that the number of magnets to be used can be reduced at the maximum to achieve low cost. Then, the multiple permanent magnets provided around the magnetic conductor enables increasing magnetic flux concentration effect while preventing magnetic flux leakage. Thus, both high efficiency and high performance of the motor can be achieved.

As illustrated in FIGS. 1, 2, and 3, the present example embodiment provides the rotor yoke 11 that is formed by stacking multiple silicon steel sheets in the axial direction. The rotor yoke 11 is provided with the multiple accommodation holes 111 in the circumferential direction, the accommodation holes 111 passing through the rotor yoke 11 in the axial direction. Then, one magnetic pole core group 12 is provided for each accommodation hole 111.

According to the present example embodiment, the number of the accommodation holes 111 and the magnetic pole core groups 12, and positions of the accommodation holes 111 and the magnetic pole core groups 12 in the circumferential direction and the radial direction, may be set according to actual needs.

According to the present example embodiment, two adjacent magnetic pole core groups 12 include the respective multiple first permanent magnets 122 that are opposite to each other in magnetic pole direction. For example, when the first permanent magnets 122 in one magnetic pole core group of the two adjacent magnetic pole core groups have a magnetic pole direction pointing radially inward of the one magnetic pole core group, the first permanent magnets 122 in the other magnetic pole core group have a magnetic pole direction pointing radially outward of the other magnetic pole core group.

According to the present example embodiment, each magnetic pole core group 12 is identical in structure, so that specific structure of one of the magnetic pole core groups 12 will be described below.

According to the present example embodiment, the magnetic conductor 121 has a polygonal section taken along the axial direction, and a specific shape of the polygon may be set depending on actual needs.

For example, the magnetic conductor 121 has a hexagonal section taken along the axial direction as illustrated in FIGS. 1 and 2.

According to the present example embodiment, the first permanent magnets 122 are each a rectangular parallelepiped, and the first permanent magnets 122 each have a length equal to a dimension of each side of the magnetic conductor 122 as illustrated in FIGS. 1 and 3.

This structure facilitates manufacturing of the magnetic conductor 121 and the first permanent magnets 122.

As illustrated in FIG. 3, the magnetic conductor 121 is larger in dimension in the axial direction than each of the first permanent magnets 122. For example, the magnetic conductor 121 has a surface facing the stator in the axial direction, the surface protruding from an end surface of the rotor yoke 11, the end surface facing the stator, and then the first permanent magnets 122 are flush with the end surface of the rotor yoke 11, facing the stator. Alternatively, each of the first permanent magnets 122 may have an end surface recessed to a side opposite to the stator from the end surface of the rotor yoke 11.

Then, a magnetic flux can be better guided to move toward the stator.

According to the present example embodiment, the rotor core has the rotor structures in at least two layers, and the rotor structure in each layer may have the rotor yoke and the multiple magnetic pole core groups. For example, the rotor structure in each layer may have the structure illustrated in FIGS. 1 to 3.

Then, providing the multilayer structure enables the motor to be further improved in efficiency and performance.

The present example embodiment describes the rotor core having rotor structure of two layers as an example.

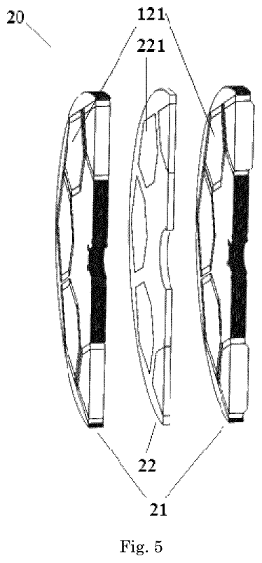

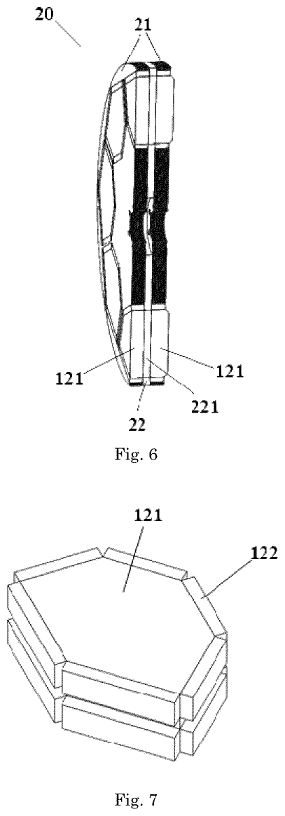

FIG. 4 is an exploded view of a rotor core with another structure according to the first example embodiment of the present disclosure. FIG. 5 is an exploded sectional view of the rotor core with the other structure according to the first example embodiment of the present disclosure. FIG. 6 is a sectional view of the rotor core with the other structure according to the first example embodiment of the present disclosure.

As illustrated in FIGS. 4, 5, and 6, the rotor core 20 has rotor structures 21 in two layers, and the rotor structure 21 in each layer includes the rotor yoke 11 and the multiple magnetic pole core groups 12. The rotor structure 21 in each layer is the same as the structure of the rotor core 10 illustrated in FIGS. 1 to 3, and thus duplicated description of specific structure is eliminated.

The rotor core 20 further includes a spacing structure 22 provided between the adjacent rotor structures 21 in two layers. The spacing structure 22 includes multiple second permanent magnets 221 connecting the magnetic conductors 121 corresponding to the adjacent rotor structures 21 in the two layers.

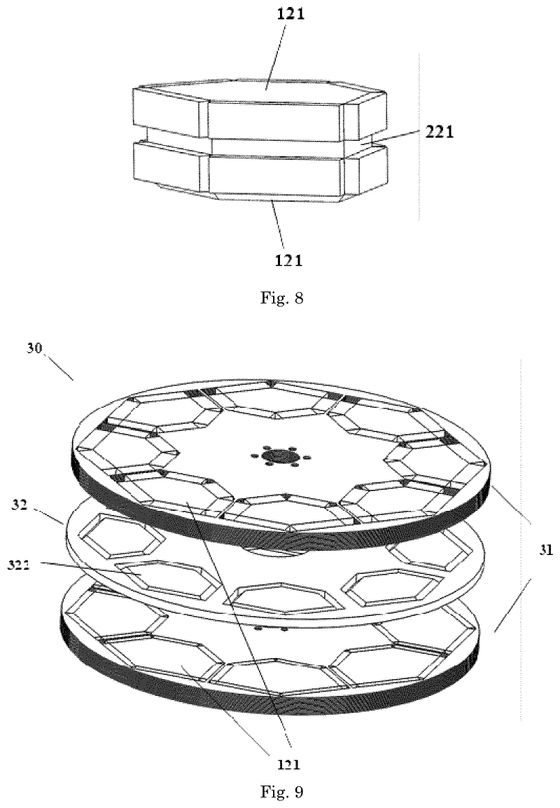

FIG. 7 is a plan view of partial structure of the rotor core according to the first example embodiment of the present disclosure. FIG. 8 is a front view of the partial structure of the rotor core according to the first example embodiment of the present disclosure.

As illustrated in FIGS. 7 and 8, the magnetic conductors 121 corresponding to the adjacent rotor structures 21 in two layers are identical in dimension in a section taken along the axial direction. Then, the second permanent magnet 221 connecting the corresponding two magnetic conductors 121 has two end surfaces in the axial direction that are also identical in dimension.

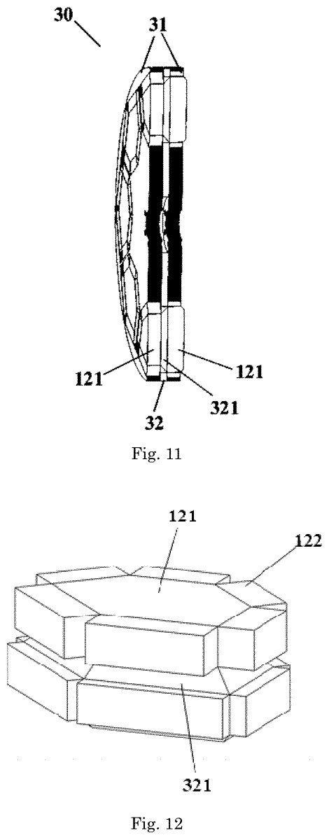

FIG. 9 is an exploded view of a rotor core with yet another structure according to the first example embodiment of the present disclosure. 10 is an exploded sectional view of the rotor core with the yet other structure according to the first example embodiment of the present disclosure. FIG. 11 is a sectional view of the rotor core with the yet other structure according to the first example embodiment of the present disclosure.

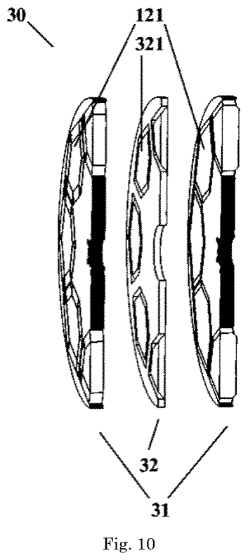

As illustrated in FIGS. 9, 10, and 11, a rotor core 30 has rotor structures 31 in two layers, and the rotor structure 31 in each layer includes the rotor yoke 11 and the multiple magnetic pole core groups 12. The rotor structure 31 in each layer is the same as the structure of the rotor core 10 illustrated in FIGS. 1 to 3, and thus duplicated description of specific structure is eliminated.

The rotor core 30 further includes a spacing structure 32 provided between the adjacent rotor structures 31 in two layers. The spacing structure 32 includes multiple second permanent magnets 321 connecting the magnetic conductors 121 corresponding to the adjacent rotor structures 31 in the two layers.

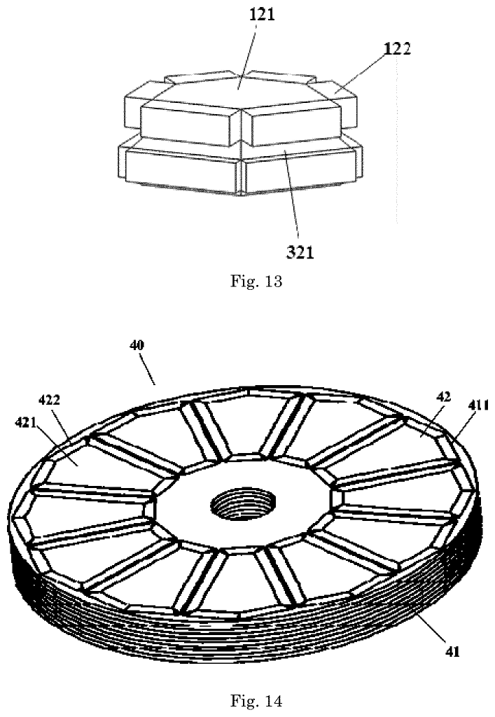

FIG. 12 is a plan view of another partial structure of the rotor core according to the first example embodiment of the present disclosure. FIG. 13 is a front view of the other partial structure of the rotor core according to the first example embodiment of the present disclosure.

As illustrated in FIGS. 12 and 13, the magnetic conductors 121 corresponding to the adjacent rotor structures 31 in two layers are identical in shape in a section taken along the axial direction and different in dimension in the section. Then, the second permanent magnet 321 connecting the corresponding two magnetic conductors 121 have two end surfaces in the axial direction that are also different in dimension. Then, a magnetic flux can be better guided to move toward the stator.

As can be seen from the above example embodiment, when the rotor yoke is provided with the multiple magnetic pole core groups in the circumferential direction and each magnetic pole core group includes the magnetic conductor at its center and the multiple permanent magnets around the magnetic conductor, structure becomes compact and reliable as a whole, and thus another mechanical structure for maintaining rigidity of the rotor is not required. The method for manufacturing the magnetic pole core groups facilitates mass production and manufacturing without causing a cumulative error in manufacturing and assembly. The center of each magnetic pole core group is formed of the magnetic conductor, so that the number of magnets to be used can be reduced at the maximum to achieve low cost. Then, the multiple permanent magnets provided around the magnetic conductor enables increasing magnetic flux concentration effect while preventing magnetic flux leakage. Thus, both high efficiency and high performance of the motor can be achieved.

A second example embodiment of the present disclosure further provides a rotor core.

FIG. 14 is a plan view of a rotor core according to the second example embodiment of the present disclosure. FIG. 15 is a bottom view of the rotor core according to the second example embodiment of the present disclosure.

As illustrated in FIGS. 14 and 15, a rotor core 40 includes a rotor yoke 41 formed by stacking multiple silicon steel sheets in an axial direction of the rotor yoke, and multiple magnetic pole core groups 42 accommodated in respective accommodation holes 411 provided in the rotor yoke 41 in a circumferential direction of the rotor yoke. The magnetic pole core groups 42 each include a third permanent magnet 421 provided at a center of each magnetic pole core group and multiple fourth permanent magnets 422 provided around a periphery of the third permanent magnet 421. The third permanent magnet 421 has a magnetic pole direction that points to one side in the axial direction and the multiple fourth permanent magnets 422 each have a magnetic pole direction that points radially inward or radially outward of each of the magnetic pole core groups 42.

Then, when the rotor yoke 41 is provided with the multiple magnetic pole core groups 42 in the circumferential direction and each magnetic pole core group 42 includes the permanent magnet 421 at its center and the multiple permanent magnets 422 around this permanent magnet, structure becomes compact and reliable as a whole, and thus another mechanical structure for maintaining rigidity of the rotor is not required. The method for manufacturing the magnetic pole core groups 42 facilitates mass production and manufacturing without causing a cumulative error in manufacturing and assembly. Both the center and the periphery of each magnetic pole core group 42 are formed of the permanent magnets, so that the magnetic flux concentration effect can be increased while magnetic flux leakage is prevented. Thus, high efficiency and high performance of the motor can be ensured to the maximum.

As illustrated in FIGS. 14 and 15, the present example embodiment provides the rotor yoke 41 that is formed by stacking multiple silicon steel sheets in the axial direction. The rotor yoke 41 is provided with the multiple accommodation holes 411 in the circumferential direction, the accommodation holes 411 passing through the rotor yoke 41 in the axial direction. Then, one magnetic pole core group 42 is provided for each accommodation hole 411.

According to the present example embodiment, the number of the accommodation holes 411 and the magnetic pole core groups 42, and positions of the accommodation holes 411 and the magnetic pole core groups 42 in the circumferential direction and the radial direction, may be set according to actual needs.

For example, the multiple magnetic pole core groups 42 each include the multiple fourth permanent magnets 422 close to a center hole 412 of the rotor yoke, the multiple fourth permanent magnets 422 being provided around the center hole 412, as illustrated FIGS. 14 and 15.

According to the present example embodiment, two adjacent magnetic pole core groups 42 include the respective multiple fourth permanent magnets 422 that are opposite to each other in magnetic pole direction. For example, when the fourth permanent magnets 422 in one magnetic pole core group of the two adjacent magnetic pole core groups have a magnetic pole direction pointing radially inward of the one magnetic pole core group, the fourth permanent magnets 422 in the other magnetic pole core group have a magnetic pole direction pointing radially outward of the other magnetic pole core group. The multiple magnetic pole core groups include two adjacent magnetic pole core groups including the respective third permanent magnets that are opposite to each other in magnetic pole direction.

According to the present example embodiment, each magnetic pole core group 42 is identical in structure, so that specific structure of one of the magnetic pole core groups 42 will be described below.

According to the present example embodiment, the third permanent magnet 421 has a polygonal section taken along the axial direction, and a specific shape of the polygon may be set depending on actual needs.

For example, the third permanent magnet 421 has a pentagonal section taken along the axial direction as illustrated in FIGS. 14 and 15.

According to the present example embodiment, the fourth permanent magnets 422 are each a rectangular parallelepiped or a wedge-shaped cube, and the first permanent magnet 122 has a length equal to a dimension of each side of the magnetic conductor 122. When the fourth permanent magnet 422 is a wedge-shaped cube, no gap may be formed between two adjacent fourth permanent magnets 422. Then, magnetic flux leakage can be further prevented from occurring.

According to the present example embodiment, the third permanent magnet 421 is larger in dimension in the axial direction than each of the fourth permanent magnets 422. For example, the third permanent magnet 421 has a surface facing the stator in the axial direction, the surface protruding from an end surface of the rotor yoke 41, the end surface facing the stator, and then the fourth permanent magnets 422 are flush with the end surface of the rotor yoke 41, facing the stator. Alternatively, each of the fourth permanent magnets 422 may have an end surface recessed to a side opposite to the stator from the end surface of the rotor yoke 41.

Then, a magnetic flux can be better guided to move toward the stator.

As can be seen from the above example embodiment, when the rotor yoke is provided with the multiple magnetic pole core groups in the circumferential direction and each magnetic pole core group includes the permanent magnet at its center and the multiple permanent magnets around this permanent magnet, structure becomes compact and reliable as a whole, and thus another mechanical structure for maintaining rigidity of the rotor is not required. The method for manufacturing the magnetic pole core groups facilitates mass production and manufacturing without causing a cumulative error in manufacturing and assembly. Both the center and the periphery of each magnetic pole core group are formed of the permanent magnets, so that the magnetic flux concentration effect can be increased while magnetic flux leakage is prevented. Thus, high efficiency and high performance of the motor can be ensured to the maximum.

A third example embodiment of the present disclosure provides a motor including the rotor core described in the first or second example embodiment. The first and second example embodiments have already described the specific structure of the rotor core, and thus the contents of the specific structure may be adapted here. Hereinafter, the description will be eliminated.

According to the present example embodiment, the motor may be an axial flux motor.

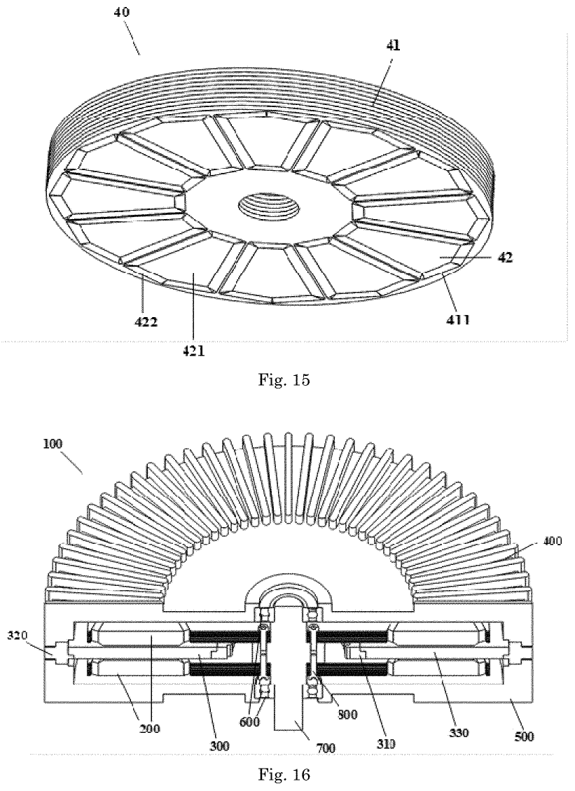

FIG. 16 is a sectional view of a motor according to the third example embodiment of the present disclosure. As illustrated in FIG. 16, a motor 100 includes two rotor cores 200 aligned in the axial direction, a stator 300 provided between the two rotor cores 200 in the axial direction, an upper cover 400, a lower cover 500, a bearing 600, a center shaft 700, and a connection structure 800.

The stator 300 includes a stator inner ring 310, a stator outer ring 320, and a stator sealing resin 330, the stator sealing resin 330 containing a coil and a core.

According to the present example embodiment, the rotor cores 200 each may include the structure of the rotor core described in any one of the first and second example embodiments. Specific structures of the stator 300, the upper cover 400, the lower cover 500, the bearing 600, the center shaft 700, and the connection structure 800, may refer to the related art.

The foregoing has described the example embodiments of the present disclosure in detail with reference to the accompanying drawings, and has also specified a manner in which the principles of the present disclosure can be used. However, it should be understood that the implementation of the present disclosure is not limited to the manner in the above example embodiments, and further includes all modifications, corrections, equivalents, and the like within a range without departing from the gist of the present disclosure.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-15. (canceled)

16. A rotor core comprising:
a rotor yoke including silicon steel sheets stacked in an axial direction of the rotor yoke; and
magnetic pole core groups accommodated in respective accommodation holes in the rotor yoke in a circumferential direction of the rotor yoke;
the magnetic pole core groups each including:
a magnetic conductor at a center of each of the magnetic pole core groups; and
first permanent magnets around a periphery of the magnetic conductor; and
the first permanent magnets each having a magnetic pole direction that points radially inward or radially outward of each of the magnetic pole core groups.

17. The rotor core according to claim 16, wherein the magnetic pole core groups include two adjacent magnetic pole core groups including the first permanent magnets that are opposite to each other in the magnetic pole direction.

18. The rotor core according to claim 16, wherein the magnetic conductor includes a polygonal section taken along the axial direction, and the first permanent magnets each have a rectangular parallelepiped shape.

19. The rotor core according to claim 16, wherein the magnetic conductor is larger in dimension in the axial direction than each of the first permanent magnets.

20. The rotor core according to claim 16, wherein the magnetic conductor protrudes from an end surface of the rotor yoke, the end surface being adjacent to a stator in the axial direction.

21. The rotor core according to claim 16, wherein
the rotor core includes rotor structures in at least two layers;
each of the rotor structures of the layers includes the rotor yoke and the magnetic pole core groups;
the rotor core further includes a spacing structure between adjacent rotor structures in two layers; and
the spacing structure includes second permanent magnets connecting the magnetic conductors corresponding to the adjacent rotor structures in the two layers.

22. The rotor core according to claim 21, wherein the magnetic conductors corresponding to the adjacent rotor structures in two layers are identical or different in dimension in a section taken along the axial direction.

23. The rotor core according to claim 22, wherein
the magnetic conductors corresponding to the adjacent rotor structures in two layers are different in dimension in a section taken along the axial direction; and
each of the second permanent magnets connecting the corresponding two magnetic conductors includes two end surfaces in the axial direction, the two end surfaces being different in dimension.

24. A rotor core comprising:
a rotor yoke including silicon steel sheets stacked in an axial direction of the rotor yoke; and
magnetic pole core groups accommodated in respective accommodation holes in the rotor yoke in a circumferential direction of the rotor yoke;
the magnetic pole core groups each including:
a third permanent magnet at a center of each magnetic pole core group; and
fourth permanent magnets around a periphery of the third permanent magnet;
the third permanent magnet having a magnetic pole direction that points to one side in the axial direction; and
the fourth permanent magnets each have a magnetic pole direction that points radially inward or radially outward of each of the magnetic pole core groups.

25. The rotor core according to claim 24, wherein
the magnetic pole core groups include two adjacent magnetic pole core groups including the fourth permanent magnets that are opposite to each other in the magnetic pole direction; and
the magnetic pole core groups include two adjacent magnetic pole core groups including the respective third permanent magnets that are opposite to each other in the magnetic pole direction.

26. The rotor core according to claim 24, wherein
the third permanent magnet includes a polygonal section taken along the axial direction; and
the fourth permanent magnets each have a shape that is a rectangular parallelepiped or a wedge-shaped cube.

27. The rotor core according to claim 24, wherein the third permanent magnet is larger in dimension in the axial direction than each of the fourth permanent magnets.

28. The rotor core according to claim 24, wherein the third permanent magnet protrudes from an end surface of the rotor yoke, the end surface being adjacent to the stator in the axial direction.

29. The rotor core according to claim 24, wherein the magnetic pole core groups each include the fourth permanent magnets adjacent to a center hole of the rotor yoke, the fourth permanent magnets being positioned around the center hole.

30. A motor comprising the rotor core according to claim 16.
